(19) United States
(12) Patent Application Publication
(10) Pub. No.: US 2003/0016718 A1
(43) Pub. Date: Jan. 23, 2003

(54) Laser structure, light emitting device, display unit, optical amplifier, and method of producing laser structure

(76) Inventors: Atsushi Toda, Kanagawa (JP); Akira Ishibashi, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/145,361

(22) Filed: May 14, 2002

(30) Foreign Application Priority Data
May 18, 2001 (JP) P2001-150069

(51) Int. Cl. H01S 3/14; H01S 3/06

(52) U.S. Cl. 372/66; 372/68; 385/901

(57) ABSTRACT

A laser structure of the present invention is composed of microparticles cyclically arrayed so as to have a face centered cubic lattice structure or a closest-packed hexagonal lattice structure. Bragg reflection occurs from such regularly arrayed microparticles. The laser structure causes laser oscillation with a luminous material such as a pigment or an organic electroluminescence material taken as a laser medium. The laser structure has an advantageous that it is small in both size and weight and can be easily produced, and is applicable to a variety of application fields such as a light emitting device, an image display unit, and an optical amplifier.

### BACKGROUND OF THE INVENTION

The present invention relates to a laser structure applicable widely for the optoelectronic field, a light emitting device, a display unit, and an optical amplifier each of which uses the laser structure, and a method of producing the laser structure.

As related art laser structures, there have been known a gas laser structure and a semiconductor laser structure. The gas laser is adapted to cause laser oscillation by pumping gas, wherein a resonator is formed of a mirror. Meanwhile, the semiconductor laser is adapted to cause laser oscillation by pumping a semiconductor, wherein a resonator is formed of an end face taken as a mirror. In addition to these gas laser and semiconductor laser, laser oscillation using a microsphere laser has been recently reported According to the microsphere laser technique, each of the microspheres is taken as a resonator, wherein laser oscillation is generated by circulation of light in each microsphere under a full-reflection condition (Whispering Gallery Modes). Such a microsphere laser technique has been described in documents, for example, “Chemistry”, Vol. 47, No. 3, pp. 156 (1992) and “Chemistry and Industry”, Vol. 45, No. 6, pp. 1110 (1992). The technique for realizing laser oscillation using microspheres has been also described in Japanese Patent Laid-open No. Hei 5-61080.

The gas laser technique has basically disadvantages in terms of enlarged size of the system and increased power consumption. Additionally, a large cooling mechanism must be sometimes provided, a process of producing the gas laser becomes complex because of the need of provision of a mirror and a gas tube, and a high-grade technique is required for maintenance. With respect to an oscillation wavelength, the gas laser cannot emit light of a certain wavelength range because the oscillation wavelength is dependent on a physical property of a gas used for the gas laser.

The semiconductor laser technique has disadvantages that the fabrication process becomes complicated and the semiconductor laser system becomes expensive because a semiconductor is grown on a substrate using a high-level growth technique such as MBE or MOCVD. With respect to an oscillation wavelength, the semiconductor laser cannot emit light of a certain wavelength range such as an ultraviolet region in which a wavelength is shorter than 380 nm and an infrared region in which a wavelength is 2 μm or more because the oscillation wavelength is dependent on a physical property of a semiconductor of the semiconductor laser.

The microsphere laser causes oscillation by circulation of light in the microsphere under a strengthened phase condition. In this case, since light is forcibly confined in the microsphere, the light circulates in the microsphere while being repeatedly reflected under a full-reflection condition. As a result, leakage of light out of the microsphere becomes small, and accordingly, it is difficult to obtain a large optical power. Also, since the pumping manner is limited to optical pumping or the like, there is a limitation to the application range of the microsphere laser.

### SUMMARY OF THE INVENTION

An object of the present invention is to provide a laser structure, which is small in both size and weight and is easily produced and thereby applicable to a variety of application fields, and an application device thereof, and further, a method of producing the laser structure.

To achieve the above object, according to a first aspect of the present invention, there is provided a laser structure including a plurality of microparticles cyclically arrayed, wherein the laser structure causes laser oscillation with diffraction light due to Bragg reflection from the microparticles taken as pumping light. Gaps among the microparticles may be filled with a luminous material that becomes luminous by means of light having a wavelength satisfying a Bragg condition for the microparticles. Alternatively, the microparticles may contain the luminous material. As the luminous material, there may be used a pigment material or an organic electroluminescence material.

According to the laser structure of the present invention, the cyclic array of the plurality of microparticles forms a grating. When light is made incident on the grating, Bragg reflection occurs by the cyclic array, to cause diffraction light having a sharp peak at a specific wavelength. Such diffraction light is used as a pumping source. The luminous material as a laser medium, for example, a pigment or an organic electroluminescence material, is irradiated with the pumping light, to obtain a desired laser power. The laser medium is a material portion in which an inverted population state is formed by pumping. The laser medium is disposed in the microparticles or in gaps among the microparticles, and is pumped at the time of laser irradiation.

According to a second aspect of the present invention, there is provided a light emitting device including a laser structure including a plurality of microparticles cyclically arrayed so as to cause laser oscillation with diffraction light due to Bragg reflection from the microparticles taken as pumping light, and a pair of waveguides being in contact with the laser structure.

As described above, pumping light is introduced from a pumping source to the laser structure that causes laser oscillation by Bragg reflection. According to the present invention, pumping light is introduced to each of the pair of waveguides, and laser oscillation starts when a total energy penetrating in the laser structure from the pair of waveguides exceeds a threshold value.

These waveguides can be formed into a matrix pattern, to form a display device. According to a third aspect of the present invention, there is provided a display unit including waveguides arrayed in a matrix pattern, and laser structures provided at respective intersections between the waveguides, wherein the laser structure includes a plurality of microparticles cyclically arrayed so as to cause laser oscillation with diffraction light due to Bragg reflection from the microparticles taken as pumping light.

With this the display unit, since the waveguides are disposed into a matrix pattern, pumping light to be introduced in the waveguides can be used as a selection signal. Accordingly, display of information can be performed by selecting one line in the horizontal direction, and feeding a signal corresponding to the selection line to a plurality of lines in the vertical direction, and further, screen display can be performed by sequentially moving the selection line. Color display can be also realized by preparing three kinds of laser structures causing laser oscillation so as to emit light of three primary colors. The adjustment of such emission color can be easily realized by adjusting the laser medium of each laser structure.

As another display unit of the present invention, in place of using the waveguides arrayed in a matrix pattern, a laser structure including a plurality of microparticles cyclically arrayed may be disposed on a transparent supporting plane. With such a structure, as means for introducing pumping light, there may be used means of irradiating the laser structure with an electron beam that is scanned, or means of irradiating the laser structure with a laser beam.

With this display unit, light from an electron gun or another laser device is used as pumping light for laser oscillation of the laser structure, so that screen display can be realized by scanning the pumping light and color display can be realized by preparing three kinds of laser structures that cause laser oscillation so as to emit light of three primary colors.

According to a fourth aspect of the present invention, there is provided an optical amplifier including a laser structure disposed in a waveguide, the laser structure including a plurality of microparticles cyclically arrayed so as to cause laser oscillation with diffraction light due to Bragg reflection from the microparticles taken as pumping light, wherein light passing through the waveguide is amplified by the laser structure. An optical fiber may be used as one example of the waveguide used for the optical amplifier.

The laser structure causes laser oscillation in a pumping state, and the laser structure is irradiated with pumping light for obtaining the pumping state. Light passing through the waveguide is used as part of such light. The light passing through the waveguide is thus optically amplified by the laser structure. Such an optical amplifier can be applied to a variety of application fields.

According to a fifth aspect of the present invention, there is provided a method of producing a laser structure, including the steps of dispersing a plurality of microparticles in liquid, and depositing the plurality of microparticles in a bottom portion of the liquid, thereby forming a laser structure composed of a cyclic array of the microparticles.

With this method of the present invention, since the microparticles can be uniformly dispersed in a solution, and can be deposited in a bottom portion of the solution by a dead weight of the microparticles. The microparticles can be regularly arrayed by equalizing sizes of the microparticles. As a result, a cyclic array of the microparticles functioning as a grating for Bragg reflection can be easily realized.

### BRIEF DESCRIPTION OF THE DRAWINGS

The above and other objects, features and advantages of the present invention will becomes more apparent from the following description taken in connection with the accompanying drawings, wherein:

FIG. 1 is a schematic view showing one example of a cyclic array of microparticles of a laser structure of the present invention;

FIG. 2 is a schematic diagram showing a layer structure of the microparticles of the laser structure of the present invention;

FIG. 3 is a view illustrating a step of depositing microparticles in a method of producing a laser structure according to the present invention;

FIG. 4 is a construction diagram based on an electron micrograph of a cyclic array structure of microparticles produced by the method of producing a laser structure according to the present invention;

FIG. 5 is an enlarged diagram of the construction diagram shown in FIG. 4;

FIG. 6 is a construction diagram based on an electron micrograph of the cyclic array structure of the microparticles shown in the electron micrograph of FIG. 4, wherein the electron micrograph shown in FIG. 6 is observed with a low magnification;

FIG. 7 is a schematic sectional view showing the laser structure of the present invention, which is configured such that gaps among the microparticles are filled with a laser medium such as a pigment;

FIG. 8 is a graph showing a result of measuring a reflectance spectrum of a deposited film of microparticles forming the laser structure of the present invention;

FIG. 9 is a graph showing a result of measuring a reflection spectrum of the deposit film, which is the same as that used for measurement whose result is shown in FIG. 8, with the laser structure tilted by about 20°;

FIG. 10 is a graph showing a result of measuring a reflectance spectrum of the laser structure of the present invention, in which gaps of the microparticles are filled with a pigment;

FIG. 11 is a graph showing a light intensity dependence on a pumping intensity for the laser structure of the present invention;

FIG. 12 is a graph showing a relationship between the pumping intensity and the luminous intensity for the laser structure of the present invention;

FIG. 13 is a schematic view showing one example of a light emitting device of the present invention;

FIG. 14 is a view showing dimensions of a waveguide used for calculating a photo field and an optical power of the light emitting device;

FIG. 15 is a graph showing a relationship between an intensity of light and each of positions of respective portions of the light emitting device, which relationship is obtained as a result of calculating the photo field and optical power of the light emitting device;

FIG. 16 is a schematic view showing another example of the light emitting device of the present invention;

FIG. 17 is a schematic perspective view showing a specific example of the light emitting device shown in FIG. 13;

FIG. 18 is a schematic perspective view showing one example of an image display unit of the present invention;

FIG. 19 is a schematic perspective view showing another example of the image display unit of the present invention;

FIG. 20 is a schematic perspective view showing further another example of the image display unit of the present invention;

FIG. 21 is a schematic perspective view showing still another example of the image display unit of the present invention; and

FIGS. 22A and 22B are a schematic sectional view and a schematic perspective view showing one example of an optical fiber amplifier of the present invention, respectively.

### DETAILED DESCRIPTION OF THE PREFERRED EMBODIMENTS

Hereinafter, preferred embodiments of the present invention will be described with reference to the accompanying drawings.

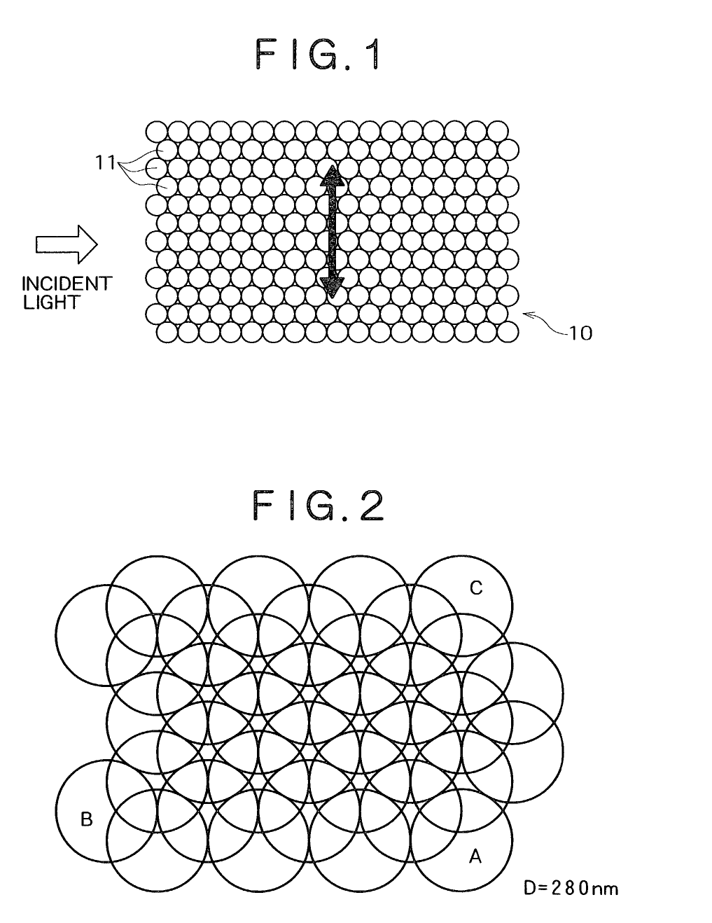

A laser structure 10 according to the present invention includes, as a base body, microparticles 11 that are cyclically arrayed as shown in FIG. 1, and is configured to cause laser oscillation by Bragg reflection from the microparticles 11.

A plurality of the microparticles 11 are composed of transparent microspheres that have nearly equal shapes and a specific refractive index. As will be described later, the microparticles 11 are arrayed in a closest packing state to form a diffraction grating, and are preferably formed into shapes of true spheres. A diameter of each of the microparticles 11 is not particularly limited insofar as it causes Bragg reflection, but may be set in a range of 10 nm to 100 μm, preferably, 10 nm to 1000 nm. These microparticles 11 may be made from a material selected from organic polymer materials, inorganic materials, and composite materials of organic materials and inorganic materials.

Examples of organic polymer materials, which are used as the organic polymer materials or composite materials for forming the microparticles, may include homopolymers or copolymers polymerized from vinyl based monomers such as styrene, methacrylate (for example, methyl methacrylate), acrylate (for example, methyl acrylate), vinyl acetate, divinylbenzene, and vinyl monomers having alicyclic groups (for example, cyclohexyl groups), and further, conjugated polymers such as polydiactylene, polythiophene, and polyparaphenylene vinylene. In the case of forming nonlinear optical portions (regions) by using only organic polymers, it is preferred to use conjugated based polymers.

If the transparent microparticles are made from only organic polymers, they may have a double layer structure that surfaces of core microparticles made from one kind organic polymer be covered with another kind of organic polymer. The transparent microparticles made from an organic polymer can be produced by a usual emulsion polymerization process, or a seed polymerization process carried out by preparing transparent microparticles by emulsion polymerization and further polymerizing a monomer while swelling the transparent microparticles with the aid of a solvent or a swelling assistant.

Examples of inorganic materials, which are used as the above inorganic materials or composite materials for forming the microparticles, may include inorganic optical materials such as various glass materials and silica, preferably, glass materials containing ions of rare earth elements, for example, Nd³⁺ (neodymium ions), Eu³⁺ (europium ions), and Er³⁺ (erbium ions), and glass materials containing ions of rare earth elements to which ions of metals such as Cr³⁺ (chromium ions) are added as needed.

An inorganic material used for the microparticles, which is made from a glass material containing ions of a rare earth element, typically has a composition that an oxide of a rare earth element (for example, Nd, Eu or Er as described above) in an amount of 10 wt % or less, usually, about 3 wt % or less is contained in glass such as silicate glass (SiO₂), phosphate glass (P₂O₅), or fluorophosphate glass (LiF, Al(PO₃)₂). The glass material having such a composition is melted at about 1500° C., generally, a composition added with a melting accelerator is melted at a temperature of 700 to 1000° C. into a glass cullet. The glass cullet is then crashed and classified into glass flakes, and the glass flakes are spherodized by a blowing process that is performed by blowing the glass flakes in flame thereby re-melting the glass flakes. The transparent microparticles made from glass are thus obtained.

The transparent microparticles made from a composite material of an inorganic material and an organic polymer material are obtained, for example, by preparing true-spherical core microparticles made from one kind of inorganic or organic polymer material and covering surfaces of the core microparticles with another kind of organic polymer or inorganic material. The transparent microparticles made from such a composite material is typically obtained by treating surfaces of glass beads with a silane coupling agent having vinyl groups and polymerizing the above-described vinyl based monomer on the surfaces of the glass beads by using a radical polymerization initiator such as benzoyl peroxide. In addition, the transparent microparticles made from a composite material may be produced from polysiloxane or polysilane having organic based substitutional groups obtained by a sol-gel process, or produced by treating surfaces of microparticles with polysiloxane or polysilane having organic based substitutional groups by the sol-gel process.

The microparticles thus obtained are cyclically arrayed so as to cause Bragg reflection therefrom. A Bragg condition for causing Bragg reflection is given by the following formula:

λ=2nΛ/m

where “λ” is a wavelength, “n” is a mode refractive index (n˜about 1.3), Λ is a cycle of a grating, and “m” is an order. In the laser structure according to this embodiment, light having a wavelength set to satisfy such a Bragg condition is used as pumping light.

FIG. 2 is a schematic diagram showing a cyclic array of the microparticles forming the laser structure of the present invention. In this figure, a plurality of layers of three kinds of microspheres A, B and C are sequentially stacked to each other. To obtain a closest-packed cyclic array of the microspheres, for example, having a face centered cubic lattice structure, one cycle of the cyclic array may be formed by sequentially stacking one layer of the microspheres A, one layer of microspheres B, and one layer of microspheres C. More concretely, assuming that a plane of the layer of the microspheres A is taken as an A-plane, a plane of the layer of the microspheres B is taken as a B-plane, and a plane of the layer of the microspheres C is taken as a C-plane, the cyclic array having the face centered cubic lattice structure is obtained by repeating the A-plane, B-plane, C-plane, A-plane, B-plane, C-plane, . . . In this cyclic array, if a diameter D of each of the microspheres A, B, and C is set to 280 nm, a size Λ of one cycle becomes 727.5 nm.

A closest-packed cyclic array of the microparticles is not necessarily configured to have a face centered cubic lattice structure but may be configured to have a closest-packed hexagonal lattice structure. To obtain a cyclic array having a closest-packed hexagonal lattice structure, the layers of two kinds of the microspheres A and B may be stacked to each other in such a manner that one cycle of the cyclic array be formed by stacking one layer of the microspheres B to one layer of microspheres A. More concretely, assuming that a plane of the layer of the microspheres A is taken as an A-plane and a plane of the layer of the microspheres B is taken as a B-plane, the cyclic array having the closest-packed hexagonal lattice structure is obtained by repeating the A-plane, B-plane, A-plane, B-plane, . . . In this cyclic array, if a diameter D of each of the microspheres A and B is set to 280 nm, a size Λ of one cycle becomes 485.0 nm.

In the case of cyclically arraying the microparticles used for the laser structure so as to cause Bragg reflection therefrom as described above, as shown in Table 1, diffraction light having a specific wavelength is obtained from each of the cyclic array having a face centered cubic lattice structure and the cylic array having a closest-packed hexagonal lattice structure.

TABLE 1

| | | CLOSEST- |
|---|---|---|
| MODE | FACE CENTERED CUBIC | PACKED HEXAGONAL |
| m | LATTICE λ (mm) | LATTICE λ (mm) |
| 1 | 1891 | 1261 |
| 2 | 946 | 630 |
| 3 | 630 | 420 |
| 4 | 473 | 315 |

As is apparent from the data shown in Table 1, assuming that the diameter of the microparticles is set to 280 nm, the wavelength λ for the face centered cubic lattice structure at the mode number of 3 is 630 nm, while the wavelength λ for the closest-packed hexagonal lattice structure at the mode number of 2 is 630 nm. This means that the wavelength of 630 nm can be obtained even for each of the structure. Accordingly, if a laser medium is made from a material allowed to be pumped with light having a wavelength of 630 nm, a laser power can be obtained regardless of whether the cyclic array have a face centered cubic lattice structure or a closest-packed hexagonal lattice structure. The laser structure using the above-described microparticles according to this embodiment becomes larger in optical loss than a related art device that causes laser oscillation by circulation of light in each of microspheres under a full-reflection condition, for example, as disclosed in Japanese Patent Laid-open No. Hei 5-61080; however, it becomes correspondingly larger in optical power than the related art device. The laser structure according to this embodiment is also advantageous in that since a photonic band and thereby a so-called photonic crystal is formed by the above-described cyclic array of the microparticles, to cause an effect of suppressing spontaneous emission light, thereby enhancing the light emission efficiency.

A method of cyclically arraying the microparticles used for the laser structure will be described below. The laser structure according to this embodiment is formed by regularly arraying microparticles each of which has a size of, for example, 1 μm or less. Here, it is important how to array very small microparticles with a good controllability. From this viewpoint, according to the arraying method of the present invention, very small microparticles can be simply arrayed with a good controllability. The method basically involves dispersing a plurality of microparticles in a vessel filled with liquid, and depositing the microparticles on a bottom portion of the vessel, thereby cyclically arraying the microparticles.

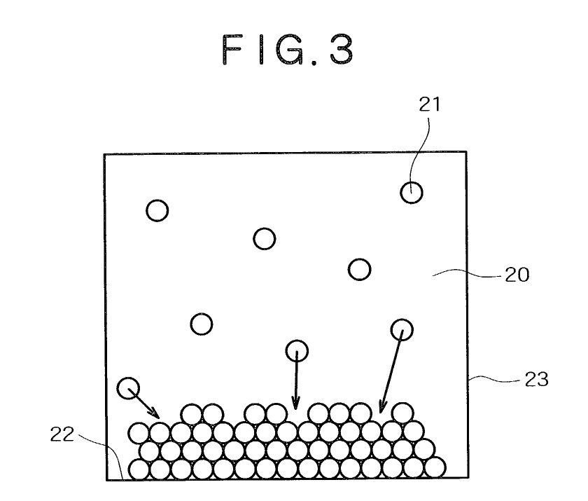

FIG. 3 is a view illustrating the method of forming the laser structure of the present invention by depositing microparticles. A large number of microparticles 21 are put in a vessel 23 filled with water 20 representative of liquid, and are dispersed in the water 20. The microparticles 21 are made from silica, each of which has a size of about 280 nm. The microparticles 21, which are initially dispersed in the water 20 depending on Brownian movement, are gradually deposited on a bottom portion 22 of the vessel 23 because a specific gravity thereof is larger than that of the water 20. Since each of the above-described face centered cubic lattice structure and closest-packed hexagonal lattice structure is stable, either of the above closest-packed structures can be obtained without the need of any special control by long-term deposition.

After the microparticles 21 are deposited, the water 20 is gradually evaporated. By gradually evaporating the water 20, not only the microparticles 21 present in the water 20 are saturated, but also the degree of the deposition of the microparticles 21 is promoted by evaporating a portion, located over the microparticles 21, of the water 20. The microparticles 21 may be deposited on a base plate that is previously disposed on the bottom portion 22 of the vessel 23. Alternatively, the microparticles 21 may be deposited on a base plate without use of the vessel 23 by coating the base plate with a solution in which the microparticles are dispersed.

The deposition of microparticles dispersed in liquid may be performed by using an electrophoresis method. This method involves electrically charging microparticles, and applying an electric field to the charged microparticles in a solution, thereby depositing the microparticles on a base plate disposed in the solution. In this case, an electric field is formed in the solution by applying a voltage to the base plate. The deposition of microparticles by using electrophoresis is advantageous in that a deposition rate can be controlled by adjusting an intensity of the electric field in the solution.

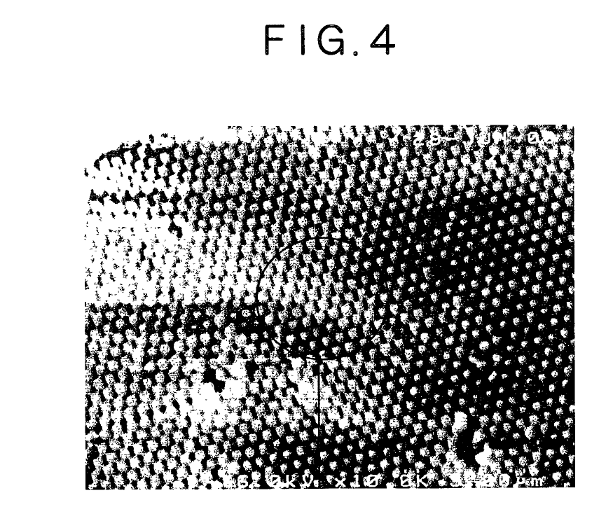

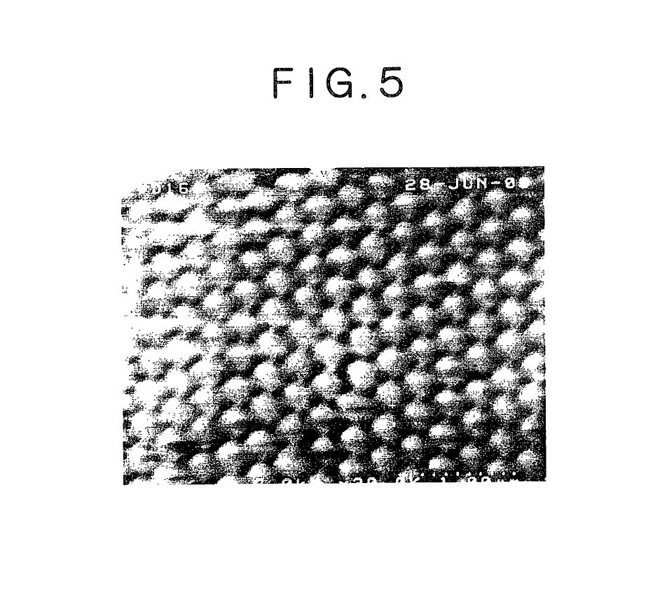

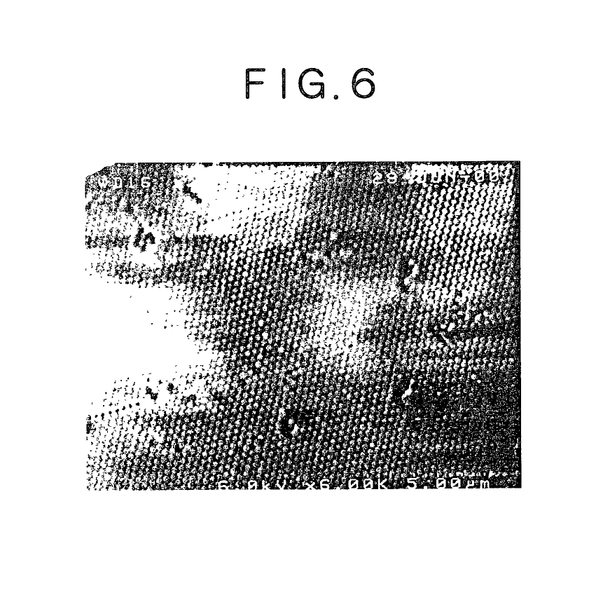

FIGS. 4 to 6 are construction diagrams based on electron micrographs for a cyclic array structure of microparticles formed by using the above-described deposition method, wherein FIG. 5 is an enlarged diagram of FIG. 4 and FIG. 6 is based on the electron micrograph observed with a low magnification. As is apparent from these figures, the microparticles are regularly arrayed, and more specifically, there is no disturbance of regularity at least in a region of 40 μm×40 μm. This means that the cyclic array structure can function as a desirable grating. In the example shown in these figures, it has taken two days to deposit the microparticles. From the array state of the structure, it is revealed that the structure has six-folded symmetry. This teaches that the cyclic array structure is a closest-packed structure.

To realize laser oscillation, in addition to the above-described cyclic array of the microparticles, a laser medium capable of creating an inverted population state by pumping must be formed. The laser medium is made from a luminous material that becomes luminous when receives light having a wavelength satisfying the Bragg condition in the microparticles, and is exemplified by a pigment material or an organic electroluminescence material. Gaps among the microparticles may be filled with such a luminous material, or such a luminous material is contained in the microparticles. As another example, the microparticles are configured as semiconductor microparticles having a band gap corresponding to oscillation wavelength or organic microparticles. As the semiconductor microparticles having such a band gap, there may be used direct transition type semiconductor microparticles such as CdSe, ZnSe, GaN, or InN, or indirect transition type semiconductor microparticles such as Si microparticles.

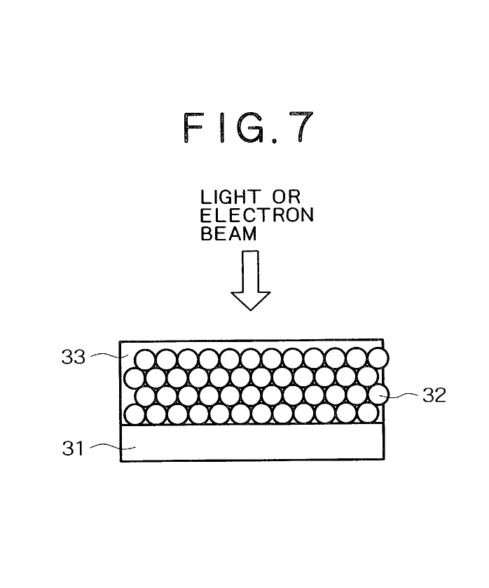

If the microparticles are not luminous, gaps among the microparticles may be filled with a laser medium. FIG. 7 is a schematic sectional view showing a structure in which gaps among microparticles are filled with a laser medium such as a pigment. A plurality of microparticles 32 are cyclically arrayed on a base plate 31, and gaps among the microparticles 32 are filled with a pigment 33. The cyclic array of the microparticles 32 has a closest-packed structure such as a face centered cubic lattice structure or a closest-packed hexagonal lattice structure capable of causing diffraction light due to Bragg reflection. By making a band gap of each of the microparticles larger than an energy corresponding to oscillation wavelength, optical absorption in the microparticles can be avoided. In this case, light or electron beam is used as a pumping source for pumping the laser medium.

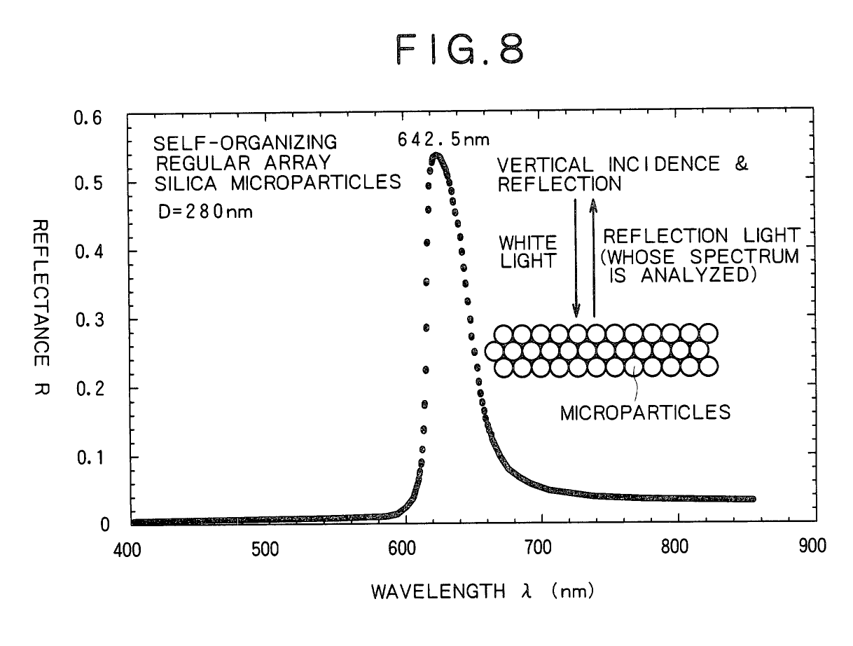

The plurality of microparticles 32 cyclically arrayed on the base plate 31 functions as a grating having a regular array of the microparticles 32. When receiving light or an electron beam, the grating causes diffraction light to the incident light. The diffraction light is taken as pumping light for pumping the pigment 33 as the laser medium. FIG. 8 is a graph showing a reflection spectrum of the deposit film. As shown in this figure, a sharp peak of the reflection spectrum appears near a wavelength of 620 nm. The reflection spectrum shown in FIG. 8 is obtained by measuring vertical reflection light to white light that is made vertically incident on a principal plane of the base plate 31. The microparticles 32 made from silica have sizes nearly equal to each other, each of which sizes is about 280 nm. A reflectance of the reflection spectrum excluding the sharp peak appearing near 620 nm becomes small. The reflection spectrum shown in FIG. 8 teaches that the cyclic array of the microparticles 32 forms a grating, which causes Bragg reflection resulting in diffraction light.

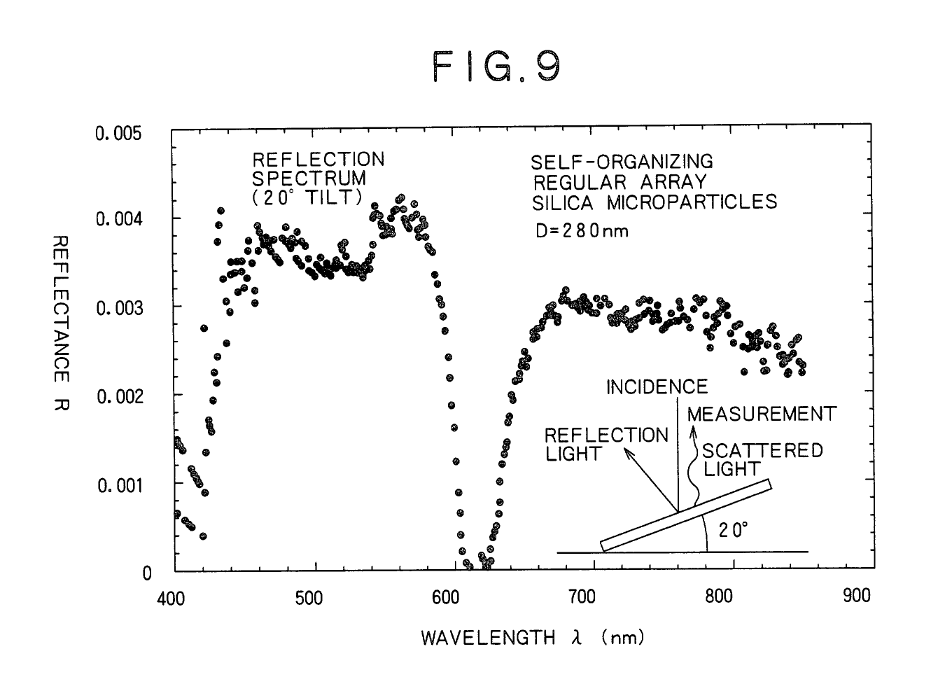

FIG. 9 is a graph showing a result of measuring a reflection spectrum of the above deposit film with the base plate 31 tilted by about 20°. As is apparent from the result shown in the figure, the reflectance of the entire spectrum becomes lower than that of the vertically measured spectrum shown in FIG. 8, and unlike the reflectance of the spectrum shown in FIG. 8, the reflectance of the spectrum shown in FIG. 9 is lowest at a wavelength near 620 nm. In the case of measuring the reflection spectrum of the deposit film with the sample of the laser structure tilted as shown in FIG. 9, scattered light is mainly measured as depicted on the right side of FIG. 9, and therefore, the reason why the spectrum is sharply dropped at a wavelength near 620 nm may be considered such that scattered light be suppressed by strong Bragg reflection at such a wavelength.

As a result of comparing the data shown in FIGS. 8 and 9 with the data of the microparticles each having a diameter of 280 nm shown in Table 1, it is apparent that the wavelength of 620 nm, near which the peak of the spectrum appears, is sufficiently close to the wavelength of 630 nm, which satisfies the Bragg condition for either the face centered cubic lattice structure or the closest-packed hexagonal lattice structure. This supports that Bragg reflection occurs in the deposit film of the laser structure.

The luminous material used to fill gaps among the microparticles is exemplified by a pigment material or an organic electroluminescence material. As a luminous pigment allowed to become luminous by the effect of optical pumping, there may be used any type of pigment insofar as it causes laser oscillation in association with the microparticles. Examples of such pigments may include organic fluorescent pigments such as Rhodamine, Nile red, and coumarin, and more specifically, Rhodamine based pigments such as Rhodamine-6G, Rhodamine-B, Rhodamine 110, Rhodamine 19, Rhodamine 13, and sulpho Rhodamine 101; coumarin based pigments such as 7-hydroxy-4-methylcoumarin, and 7-diethylamino-4-methylcoumarin; cyanine based pigments; oxazine based pigments such as oxazine 4, oxazine 1, and cresyl violet; derivatives such as stilbene, oxazole, and oxadiazole; a p-terphenyl derivative; DCM; and pyrromethene. In the case of filling gaps among the microparticles with a luminous material such as a pigment, a solid gel in which a desired pigment is dispersed may be impregnated in the gaps among the microparticles.

The present inventor has experimentally confirmed that a laser structure using a pigment material as a laser medium can realize laser oscillation of the laser structure. The laser structure used for the experiment is obtained by dissolving a pigment (Rhodamine 101 Inner Salt) in ethanol to form a pigment solution, and dipping a grating structure, in which microparticles have been cyclically arrayed as described above, in the pigment solution, thereby filling gaps among the microparticles with the pigment. An intensity of a spectrum of the laser structure obtained by filling the gaps among the microparticles with the pigment is then measured at room temperature by using a He—Cd laser (wavelength: 325 nm, power: 10 mW or less). For comparison, a spectrum of only the pigment is also measured.

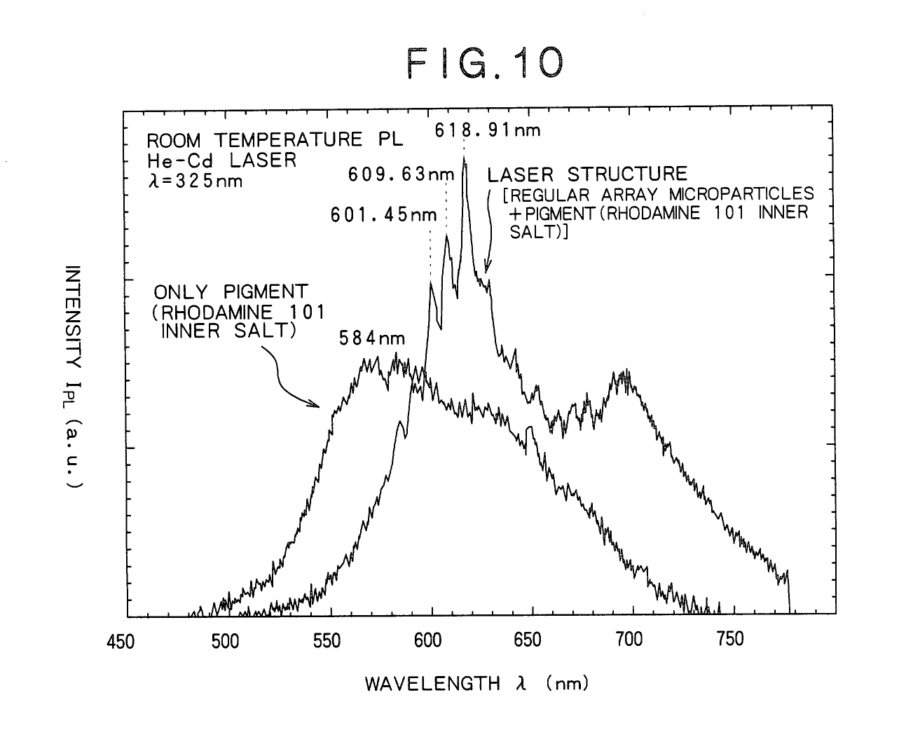

The measured results are shown in FIG. 10. In this figure, the abscissa indicates a wavelength distribution of output light, and the ordinate indicates an intensity of a peak level. The emission spectrum of only the pigment (Rhodamine) for comparison is broadened with its peak appearing at a wavelength near 584 nm. On the contrary, in the emission spectrum of the laser structure composed of the combination of the cyclically arrayed microparticles and the pigment, a sharp peak appears at a wavelength of 618.91 nm, and further, other peaks spaced from each other at intervals of a specific value of about 8 nm appear at wavelengths of 593.26 nm, 601.45 nm, and 609.63 nm. The appearance of the sharp peak in the spectrum of the laser structure means that the laser structure causes laser oscillation.

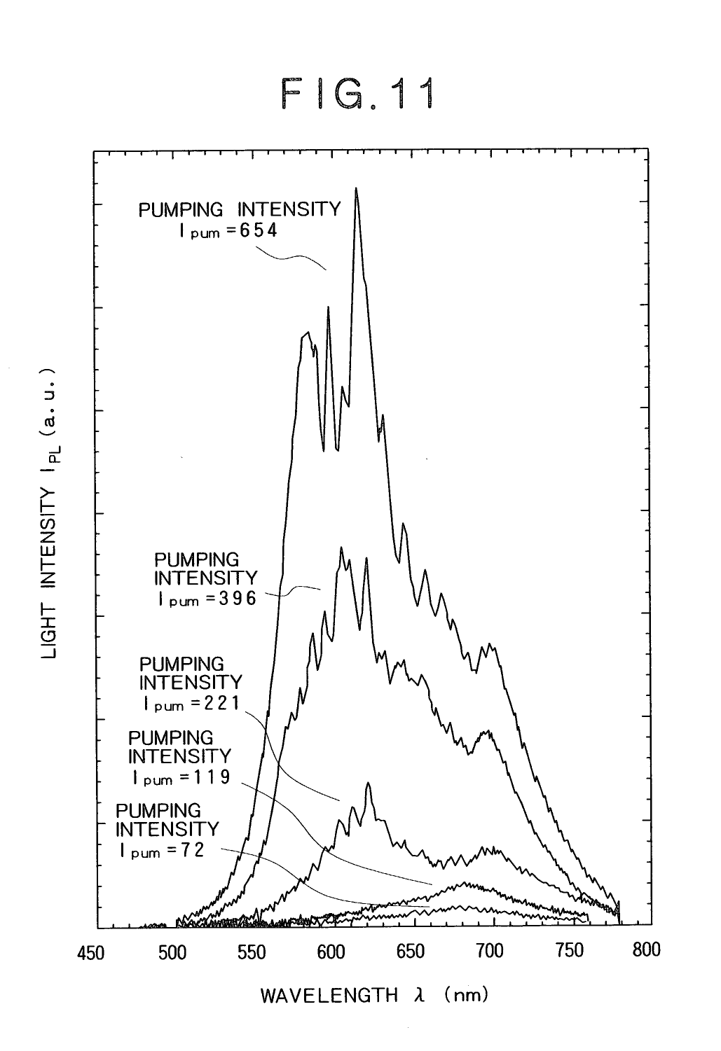

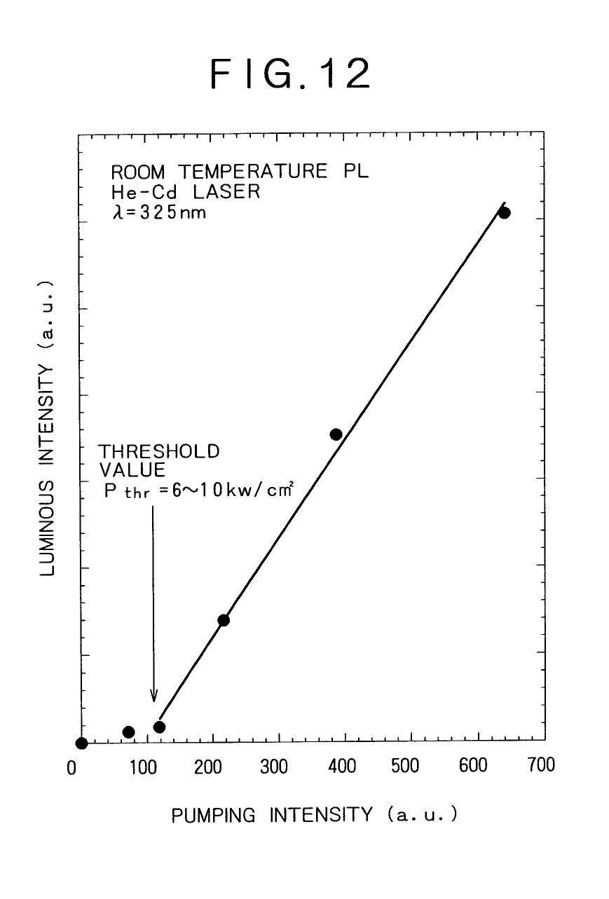

The present inventor has also examined a pumping intensity dependence on the intensity of light outputted from the laser structure. The results are shown in FIG. 11. In this figure, the abscissa indicates a wavelength distribution, and the ordinate indicates an intensity of output light. In this experiment, a change in intensity of light is measured by gradually increasing the pumping intensity in the order of 72, 119, 221, 396, and 654. As is shown in FIG. 11, with the pumping intensity being in a range of 221 or less, each spectrum distribution has a characteristic that the intensity of light is weak and the distribution is broadened as a whole, while with the pumping intensity being in a range of more than 221, that is, at 396 and 654, each spectrum distribution has a characteristic that a peak appears at a wavelength near 620 nm and the intensity of light becomes significantly large in a region of the pumping intensity between 396 and 654. FIG. 12 is a graph showing a relationship between a pumping intensity and a luminous intensity. As shown in FIG. 12, it is revealed that a threshold value is in a range of about 6 to 10 kw/cm².

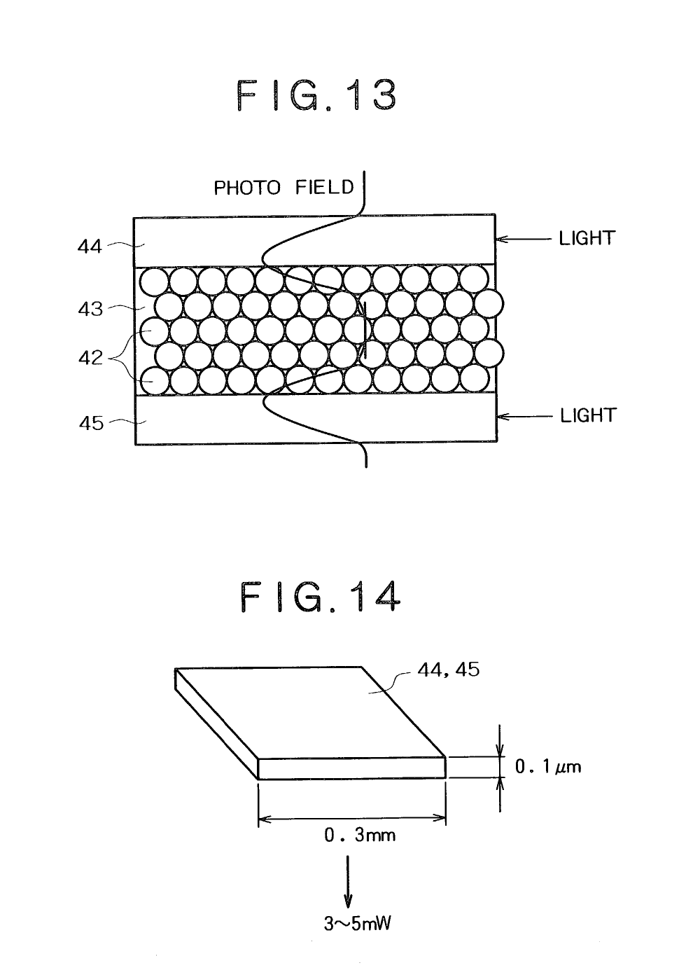

The above result shows that the pumping intensity dependence on the sharp peak at a wavelength near 620 nm has the threshold value. In a range of the threshold value or more, the sharp peak intensity is significantly increased with an increase in pumping intensity. Also in the case of increasing the pumping intensity over the threshold value, the luminous intensity becomes strong with the increase in pumping intensity. A light emitting device having a configuration that a laser structure is sandwiched between a pair of waveguides will be described below with reference to FIG. 13. The light emitting device shown in FIG. 13 has, at its central portion, a laser structure. In this laser structure, a plurality of microparticles 42 are cyclically arrayed so as to have a face centered cubic lattice structure or a closest-packed hexagonal lattice structure, so that the laser structure causes laser oscillation with diffraction light due to Bragg reflection from the microparticles 42 taken as pumping light. As described above, gaps among the microparticles 42 are filled with a pigment 43 exemplified by an organic fluorescent pigment such as Rhodamine, Nile red, or coumarin. Like the microparticles described above, the microparticles 42 are configured as transparent microparticles made from an organic polymer material such as styrene, or an inorganic material, for example, an inorganic optical material such as glass or silica.

A first waveguide 44 and a second waveguide 45, each of which is made from quartz glass or a synthetic resin, are provided on upper and lower sides of the laser structure, respectively. Part of light passing through each of the first and second waveguides 44 and 45 forms a photo field outside the waveguide 44 or 45, and such a photo field penetrates even to a portion of the laser structure. A threshold value of the laser structure is set such that the laser structure causes laser oscillation when a total of light given from the first waveguide 44 to the laser structure and light given from the second waveguide 45 to the laser structure exceeds the threshold value.

In the light emitting device having such a structure, when pumping light having a desired wavelength is introduced in each of the first and second waveguides 44 and 45 and the pumping light penetrates to a portion of the laser structure, Bragg reflection occurs in the laser structure and the laser structure causes laser oscillation when the total of light given from the first waveguide 44 and light given from the second waveguide 45 exceeds the threshold value.

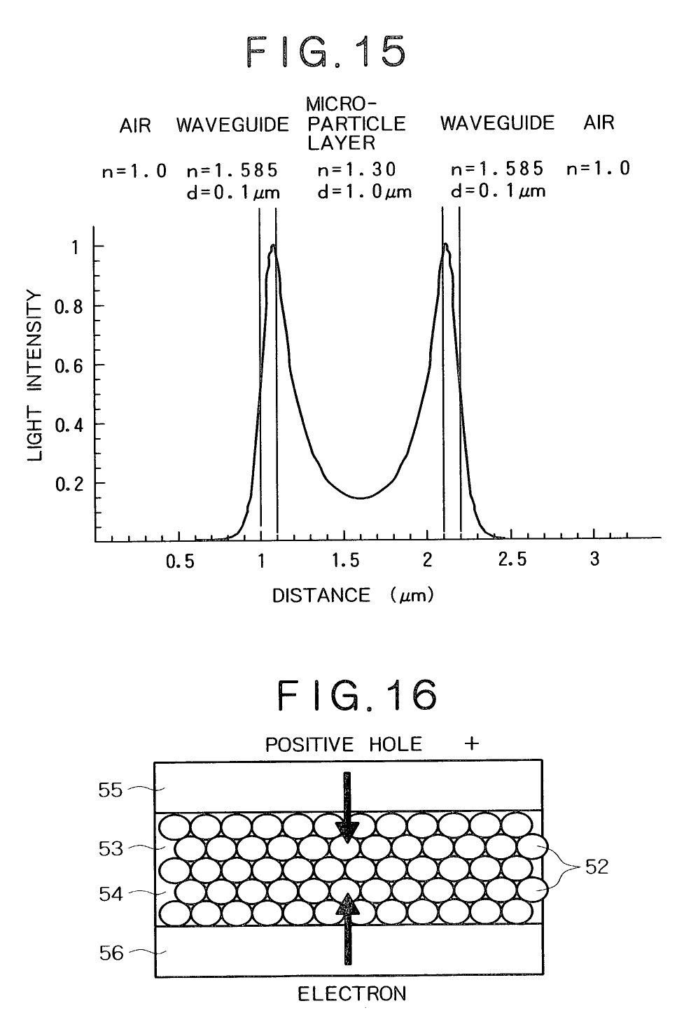

FIG. 14 is a view showing dimensions of each of the waveguides 44 and 45 used for calculating the penetration of a photo field, and FIG. 15 is a graph showing a calculated result of the penetration of a photo field In the case of using each of the waveguides 44 and 45 shown in FIG. 14, that is, in the case where a thickness of the waveguide is set to 0.1 μm and a width of a contact region of the waveguide with the laser structure is set to 0.3 mm, an optical power ranging from 3 to 5 mW is calculated for an energy of about 10.0 to 16.6 kW/cm². In addition, the waveguide is made from polycarbonate and has a refractive index of 1.585, and the microparticles of the laser structure are made from silica and have a refractive index of 1.30. In FIG. 15, the ordinate indicates an intensity of light and the abscissa indicates a distance. As is apparent from FIG. 15, a peak of the intensity of light appears in each of the waveguides, and about 60% of light penetrates to the laser structure (microparticle layer) composed of cyclically arrayed microparticles.

An optical power of the light emitting device shown in FIG. 14 is calculated as follows: namely, to obtain a threshold density of light of 6 to 10 kW/cm² in the laser structure (microparticle layer), since about 60% of light penetrates to the laser structure, it is sufficient to give an energy expressed by a light density of about 10.0 to 16.6 kW/cm² to the waveguides, and therefore, since the width of each waveguide is set to 0.3 mm as described above, an optical power of 3 to 5 mW is obtained by giving an energy of about 10.0 to 16.6 kW/cm² to the waveguides.

A display unit is produced by arranging a plurality of first waveguides extending in the vertical direction and a plurality of second waveguides extending in the horizontal direction into a matrix pattern, and interposing a laser structure at each of intersections between the first and second waveguides, wherein the laser structure contains three kinds of luminous materials of three primary colors (red, green and blue).

FIG. 16 is a view showing one example of a light emitting device in which gaps of microparticles are filled with an organic electroluminescence material. The light emitting device includes a p-type electrode 55 and an n-type electrode 56 as a pair of opposed electrodes, and a laser structure disposed between the electrodes 55 and 56. The laser structure is composed of a plurality of microparticles 52 cyclically arrayed so as to have a face centered cubic lattice structure or a closest-packed hexagonal lattice structure, wherein gaps among the microparticles 52 are filled with an organic electroluminescence material in place of an organic fluorescent pigment. The laser structure causes laser oscillation with diffraction light due to Bragg reflection from the microparticles 52 taken as pumping light. In this light emitting device, two kinds of organic electroluminescence materials are used. Gaps among the microparticles 52 on the p-type electrode 55 are filled with a p-type organic electroluminescence material 53, and gaps among the microparticles 52 on the n-type electrode 56 side are filled with an n-type organic electroluminescence material 54. The p-type organic electroluminescence material 53 is a positive-hole transfer material such as diamine, TPD, or PPV, and the n-type organic electroluminescence material 54 is an electron transfer material such as an aluminum complex Alq³ or CN-PPV. In this case, the laser structure becomes a two-layer structure (single-hetero structure); however, it may be configured as a three-layer structure (double-hetero structure). In the two-layer structure, the electron transfer material layer is taken as a luminous layer. In the three-layer structure, a luminous layer is formed between the positive-hole transfer material layer and the electron transfer material layer, and the luminous layer is made from an organic material (CBP) doped with a platinum-polyolefin complex or an Ir complex. Like the microparticles described above, the microparticles 52 are exemplified by transparent microparticles made from an organic polymer material such as styrene, or an inorganic material, for example, an inorganic optical material such as glass or silica. To improve a luminous efficiency, a luminous pigment may be doped in the positive-hole transfer material layer and the electron transfer material layer. With this structure, like a semiconductor laser, carriers are injected by applying a bias between both the electrodes 55 and 56, to cause an inverted population, thereby allowing laser oscillation.

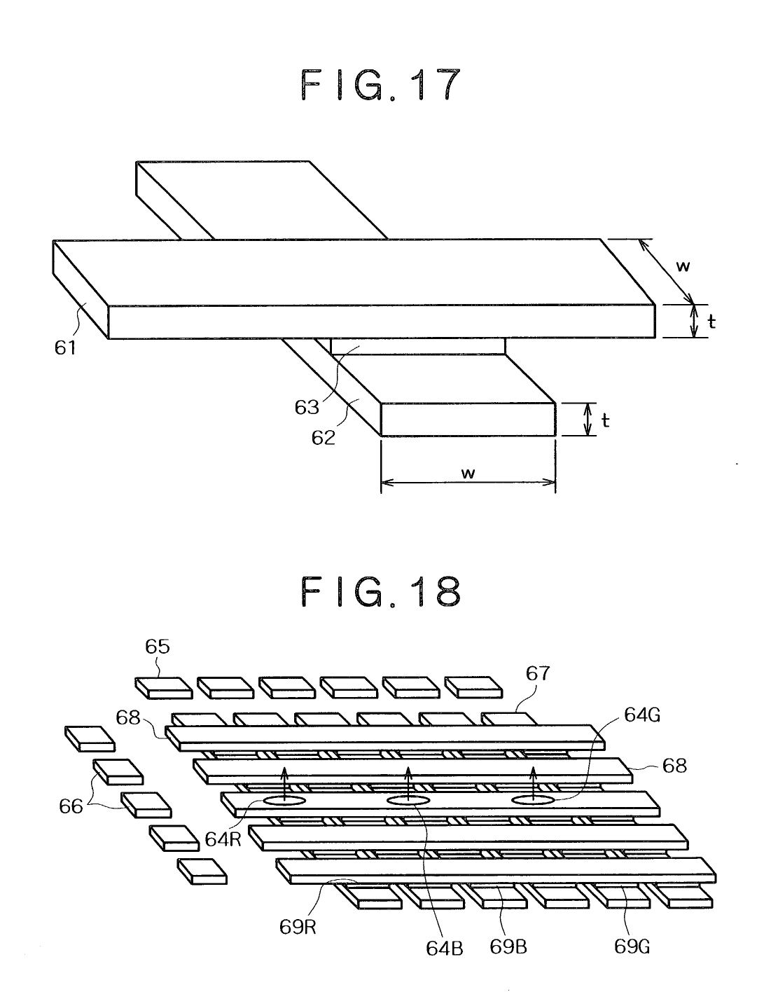

FIG. 17 is a view showing a specific example of the light emitting device shown in FIG. 13. A first waveguide 61 and a second waveguide 62 intersecting the first waveguide 61 are disposed on upper and lower sides with a laser structure 63 sandwiched therebetween at the intersection, respectively. The laser structure 63 is composed of a plurality of microparticles cyclically arrayed so as to have a face centered cubic lattice structure or a closest-packed hexagonal lattice structure, and has a function causing laser oscillation with diffraction light due to Bragg reflection from the microparticles taken as pumping light. As described above, gaps among the microparticles are filled with an organic fluorescent pigment such as Rhodamine, Nile red, or coumarin. The microparticles are exemplified by transparent microparticles made from an organic polymer material such as styrene, or an inorganic material, for example, an inorganic optical material such as glass or silica. While not shown, GaN based light emitting elements for outputting pumping light are provided on ends of the first and second waveguides 61 and 62. The light emitting device is operated by pumping light outputted from the GaN based light emitting elements.

Each of the first and second waveguides 61 and 62 of the light emitting device shown in FIG. 17 is of a thin type and has a width W and a thickness “t”. As one example, the width W and the thickness “t” can be set to the same values as those used for the above-described calculation of a photo field, that is, set to 0.3 mm and 0.1 μm, respectively. Pumping light is simultaneously made incident on the first and second waveguides 61 and 62. The pumping light penetrates the laser structure 63 positioned at the intersection between the first and second waveguides 61 and 62. When a total of light given from the first waveguide 61 to the laser structure 63 and light given from the second waveguide 62 to the laser structure 63 exceeds a threshold value associated with laser oscillation, the light emitting device can emit light outwardly. The light emitting device shown in FIG. 17 can function as an optical logic circuit or an optical arithmetic element, and concretely function as a two-input AND circuit. The light emitting device can be also configured as a type of three or more input by adjusting pumping light.

FIG. 18 is a schematic perspective view showing an image display unit produced by making use of the light emitting device shown in FIG. 17. Referring to this figure, a plurality of stripe-shaped waveguides 67 spaced from each other in parallel extend in the vertical direction, and a plurality of stripe-shaped waveguides 68 spaced from each other in parallel extend in the horizontal direction in such a manner as to intersect the waveguides 67. Each of the waveguides 67 and 68 is a stripe-shaped region that allows light to propagate therethrough, and may be configured an optical fiber made from a synthetic resin or glass. As each of the waveguides 67 and 68, there may be used an optical waveguide of a thin type shown in the figure, in which a core layer having a high refractive index is sandwiched between cladding layers each having a low refractive index. Laser structures 69R, 69G and 69B are provided at the corresponding intersections between the waveguides 67 and 68 in such a manner as to be sandwiched therebetween. Each of the laser structures 69R, 69G and 69B is composed of a plurality of microparticles cyclically arrayed so as to have a face centered cubic lattice structure or a closest-packed hexagonal lattice structure, and has a function causing laser oscillation with diffraction light due to Bragg reflection from the microparticles taken as pumping light. Since the laser structures 69R, 69G and 69B make use of different kinds of diffraction light due to different kinds of Bragg reflection from the microparticles, the sizes of the microparticles used for the laser structures 69R, 69G and 69B are different from each other. In the example shown in FIG. 18, the size of each of the microparticles used for the laser structure 69R is set to 280 nm, the size of each of the microparticles used for the laser structure 69G is set to 240 nm, and the size of each of the laser structure 69B is set to 210 nm.

Gaps among the microparticles used for each of the laser structures 69R, 69G and 69B are filled with a pigment. The pigment used for the laser structure 69R is exemplified by Rhodamine 101 Inner Salt (C₃₂H₃₀N₂O₃). A chemical structural formula of Rhodamine 101 Inner Salt is as follows:

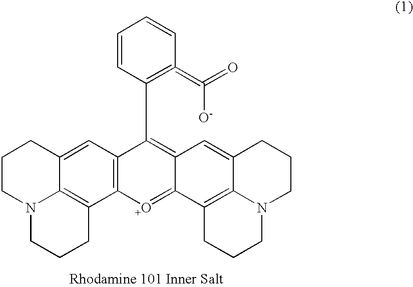

The laser structure 69R using Rhodamine 101 Inner Salt as the pigment has an oscillation wavelength of 620 nm, and emits light of red. The pigment used for the laser structure 69G is exemplified by Rhodamine B (C₂₈H₃₁ClN₂O₃). A chemical structural formula of Rhodamine B is as follows:

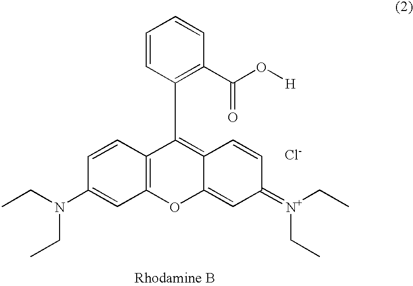

The laser structure 69G using Rhodamine B as the pigment has an oscillation wavelength of 540 nm, and emits light of green. The pigment used for the laser structure 69B is exemplified by coumarin 7 (C₂₀H₁₉N₃O₂). A chemical structural formula of coumarin 7 is as follows:

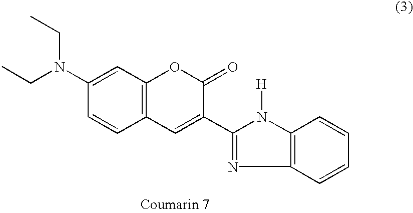

The laser structure 69B using coumarin 7 as the pigment has an oscillation wavelength of 470 nm, and emits light of blue. In this way, the image display unit shown in FIG. 18 has the structure, in which the laser structures 69R, 69G and 69B having emission wavelengths of three primary colors are arrayed, wherein each of the waveguides 67 extending in the vertical direction allows light emission of red, green, or blue and intersect three pieces of the waveguides 68 extending in the horizontal direction, to form three intersections 64R, 64G, and 64B taken as one pixel.

With respect to the waveguides 67 and 68 arrayed in a matrix pattern, a GaN based semiconductor laser 65 is provided at an end of each of the waveguides 67, and a GaN based semiconductor laser 66 is provided at an end of each of the waveguides 68. Each of the GaN based semiconductor lasers 65 and 66 is configured as a light emitting device allowing emission of light of blue-violet (wavelength: 410 nm). Optical powers of the GaN based semiconductor lasers 65 and 66 are introduced to the ends of the waveguides 67 and 68 on the basis of image information, to pump the laser structures 69R, 69G, and 69B. The pumping operations of the laser structures 69R, 69G, and 69B are performed in the same manner as that for the laser structure of the light emitting device shown in FIG. 17. That is to say, when pumping light is simultaneously introduced from the semiconductor lasers 65 and 66 to the waveguides 67 and 68 and light penetrating from the waveguides 67 and 68 to the laser structures 69R, 69G, and 69B positioned at the intersections between the waveguides 67 and 68 exceeds a threshold value, the laser structures 69R, 69G, and 69B emit light outwardly. In this image display unit, the laser structure is configured such that gaps among the microparticles are filled with the pigment; however, the present invention is not limited thereto. For example, the pigment may be contained in the microparticles, or the pigment may be not only contained in the microparticles but also put in gaps among the microparticles.

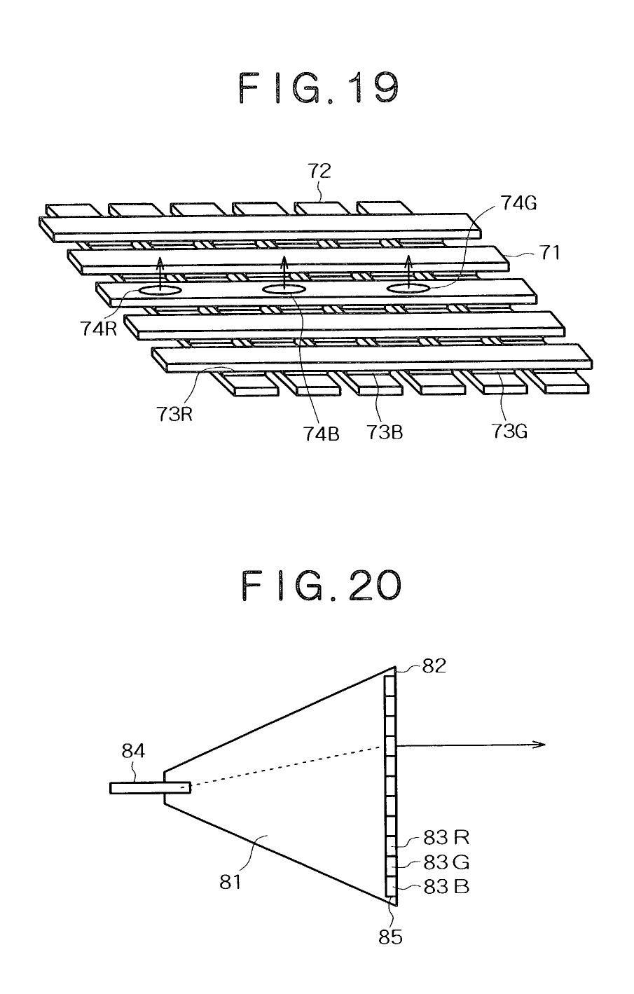

FIG. 19 is a schematic perspective view showing another image display unit produced by making use of the light emitting device shown in FIG. 17. Referring to this figure, a plurality of stripe-shaped Al—Li electrodes 72 spaced from each other in parallel extend in the vertical direction, and a plurality of stripe-shaped ITO electrodes 71 spaced from each other in parallel extend in the horizontal direction in such a manner as to intersect the Al—Li electrodes 72. Laser structures 73R, 73G and 73B are provided at the corresponding intersections between the Al—Li electrodes 72 and the ITO electrodes 71 in such a manner as to be sandwiched therebetween. The laser structure 73R contains an organic electroluminescence material allowed to become luminous in red, the laser structure 73G contains an organic electroluminescence material allowed to become luminous in green, and the laser structure 73B contains an organic electroluminescence material allowed to become luminous in blue. The laser structures 73R are disposed in one Al—Li electrode 72, the laser structures 73G are disposed in another Al—Li electrode 72, and the laser structures 73B are disposed in further another Al—Li electrode 72. The laser structures 73R, 73G, and 73B emit light of different colors.

Each of the laser structures 73R, 73G, and 73B includes a cyclically arrayed microparticles having the two-layer structure. As described in the light emitting device shown in FIG. 16, the two-layer structure has a positive-hole transfer layer formed by filling gaps among the microparticles with an organic electroluminescence material as a positive-hole transfer material and an electron transfer layer formed by filling gaps among the microparticles with an organic electroluminescence material as an electron transfer material. As these organic electroluminescence materials, there may be preferably used the following organic electroluminescence materials:

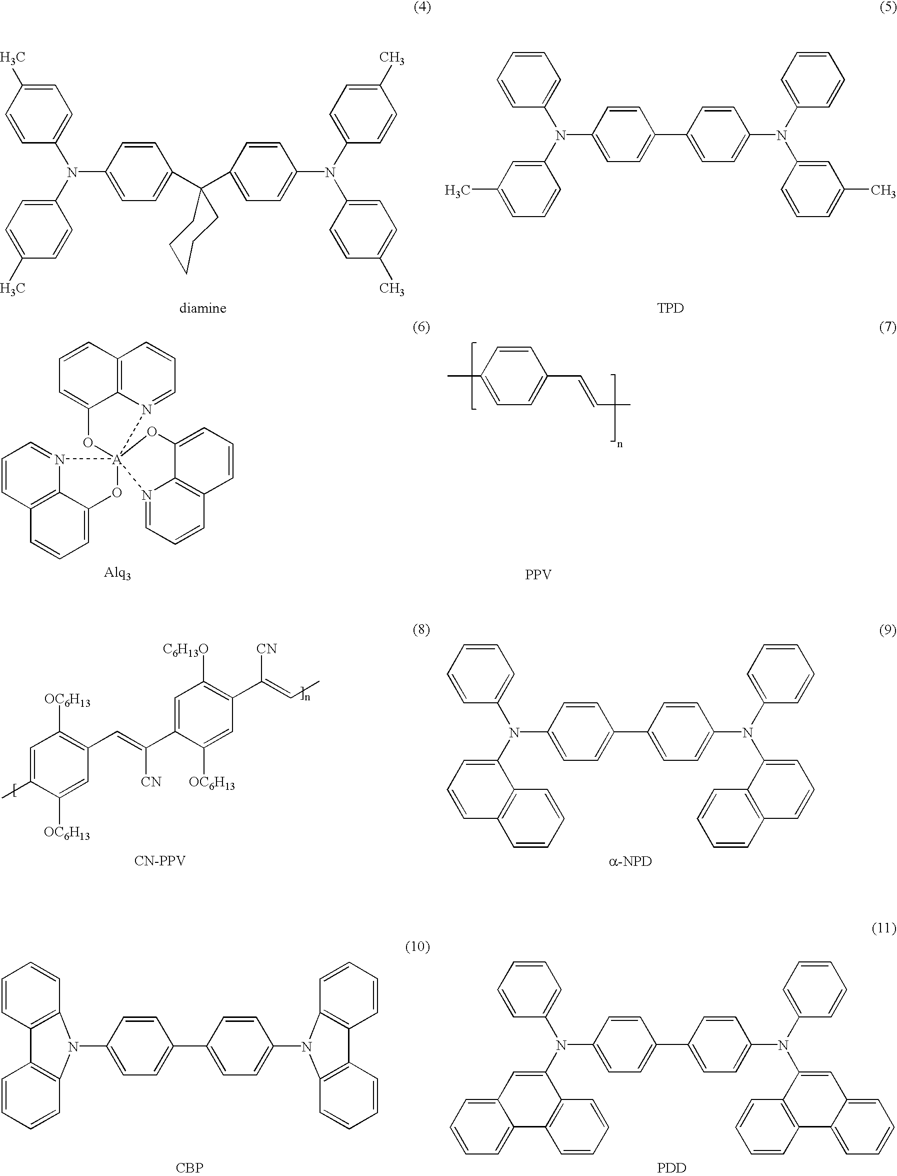

The image display unit of the present invention is not limited to that having the structure shown in FIG. 19 but may be configured as that having a structure similar to that of a cathode-ray tube shown in FIG. 20. Referring to FIG. 20, an electron gun 84 is disposed on one end side of a glass tube 81 having a hollow portion kept in vacuum. An electron beam emitted from the electron gun 84 is scanned by a deflection yoke not shown, to reach a planar portion 82 provided on the other side of the glass tube 81. As described above, a plurality of laser structures 83R having an emission wavelength for red, a plurality of laser structures 83G having an emission wavelength for green, and a plurality of laser structures 83B having an emission wavelength for blue, each of which is configured as a microparticle laser array 85, are alternately disposed on a surface, on an inner wall side of the glass tube 81, of the planar portion 82. Each of the laser structures 83R, 83G, and 83B contains a plurality of microparticles cyclically arrayed to have a face centered cubic lattice structure or a closest-packed hexagonal lattice structure, and has a function causing laser oscillation with diffraction light due to Bragg reflection from the microparticles taken as pumping light. Since the laser structures 83R, 83G and 83B make use of different kinds of diffraction light due to different kinds of Bragg reflection from the microparticles, the sizes of the microparticles used for the laser structures 83R, 83G and 83B are different from each other. Each of the laser structures 83R, 83G, and 83B is configured such that gaps among the microparticles are filled with a pigment. For example, the laser structure 83R uses Rhodamine 101 Inner Salt as the pigment and has an oscillation wavelength of 620 nm, the laser structure 83G uses Rhodamine B as the pigment and has an oscillation wavelength of 540 nm, and the laser structure 83B uses coumarin 7 as the pigment and has an oscillation wavelength of 470 nm.

The image display unit having such a structure is operated in a manner similar to that for operating a cathode-ray tube. That is to say, the laser structures 83R, 83G, and 83B are irradiated with electron beams, to cause pumping by making use of Bragg reflection from the microparticles, thereby causing laser oscillation with respective pigments taken as laser media. A laser display can be produced by alternately arraying stripe-shaped microparticle lasers allowing emission of light of three primary colors (red, green, and blue) with a pitch of, for example, 0.2 mm.

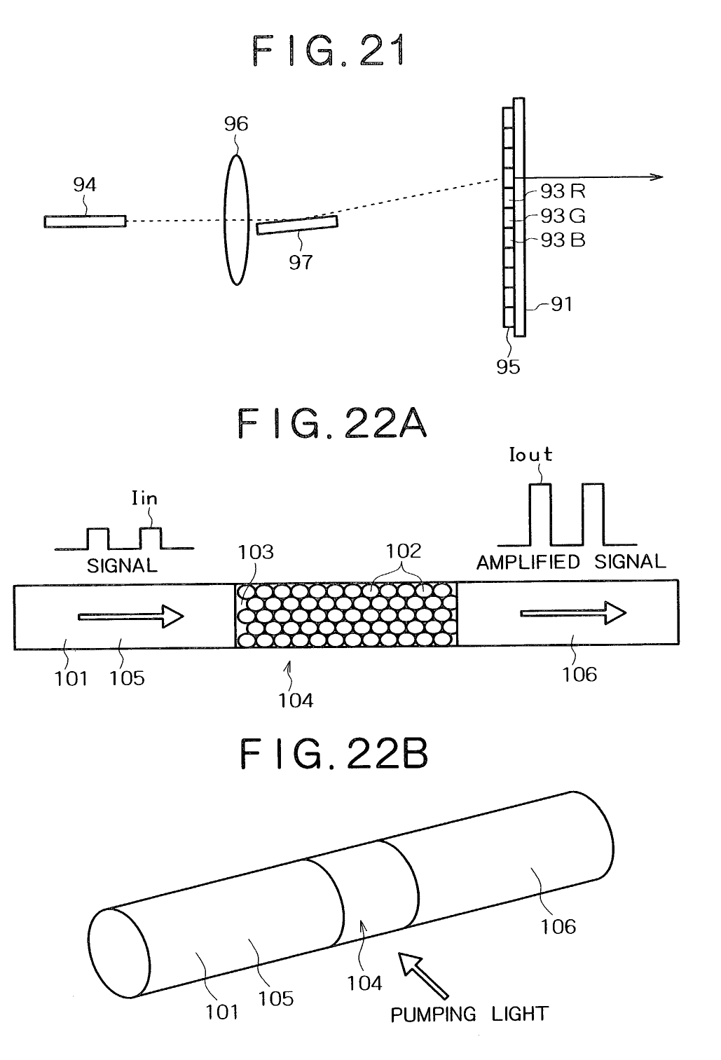

FIG. 21 is further another image display unit of the present invention. Laser structures 93R having an emission wavelength for red, laser structures 93G having an emission wavelength for green, and laser structures 93B having an emission wavelength for blue, each of which is configured as a microparticle laser array 95, are alternately disposed on a flat-plate shaped glass member 91. Each of the laser structures 93R, 93G, and 93B contains a plurality of microparticles cyclically arrayed to have a face centered cubic lattice structure or a closest-packed hexagonal lattice structure, and has a function causing laser oscillation with diffraction light due to Bragg reflection from the microparticles taken as pumping light. Each of the laser structures 93R, 93G and 93B is configured such that gaps among the microparticles are filled with a pigment, and the sizes of the microparticles are different from each other.

Unlike the electron gun 84 shown in FIG. 20, a GaN based semiconductor laser 94 is provided for the laser structures 93R, 93G, and 93B. The laser structures 93R, 93G, and 93B are irradiated with pumping light emitted from the GaN based semiconductor laser 94 functioning as a pumping source through a lens 96 and a mirror 97 for each dot. The GaN based semiconductor laser 94 is turned on or off in response to an image signal, so that the pumping states of the laser structures 93R, 93G, and 93B correspond to the image information. An optical system may be disposed on the output side of the glass member 91, to form a high brightness projector or the like.

FIGS. 22A and 22B show an optical fiber amplifier as an application example of the laser structure of the present invention to optical communication. An optical fiber amplifier 101 has a structure in which a laser structure 104 is formed in an optical fiber made from a transparent synthetic resin or glass. An input side fiber 105 is coupled to an input side of the laser structure 104, and an output side fiber 106 is coupled to an output side of the laser structure 104. The laser structure 104 is formed into a cylindrical shape having a diameter being nearly equal to that of each of the input side fiber 105 and the output side fiber 106. The shape of the laser structure 104, however, is not limited thereto. In the laser structure 104, a plurality of microparticles 102 are cyclically arrayed so as to cause Bragg reflection, and gaps of the microparticles are filled with a pigment 103. A diameter of each of the microparticles 102 and a kind of the pigment 103 are selected on the basis of an input light signal Iin, that is, selected so as to cause laser oscillation with the same wavelength as that of the input light signal Iin.

In operation of the optical fiber amplifier, the laser structure 104 is irradiated, from external, with pumping light, so that the laser structure 104 is in a state immediately before light penetrating the laser structure 104 exceeds a threshold value. When an input light signal Iin is introduced, in such a state, from the input side fiber 105 into the laser structure 104, the light is amplified by an amount corresponding to the incident pulse light, and an output light signal Iout amplified from the input light signal Iin is outputted from the output side fiber 105.

The optical fiber amplifier 101 having such a mechanism can amplify again a light signal that has been attenuated during transmission thereof from a distant place, and therefore, can be applied to long-distance optical fiber communication. The optical fiber amplifier 101 can be also used as an element for causing signal light by oscillation in the fiber, and further used as a nonlinear optical part by adjusting pumping light introduced from external. Since the laser structure 104 is very small in both size and weight, the optical fiber amplifier 101 can be used to a variety of application fields.

As described above, according to the laser structure of the present invention, the laser structure includes a plurality of cyclically arrayed microparticles and causes laser oscillation by Bragg reflection from the microparticles. As a result, the laser structure can obtain laser oscillation having a sharp peak although it is small in both size and weight. The laser oscillation of the laser structure can be applied to a variety of application fields, for example, a light emitting device, an image display unit, and an optical amplifier. In particular, the cyclic array of the microparticles can be formed on a freely selected place, and further, can be applied to light having a wavelength in a wide range by selecting a size of each of the microparticles.

According to each of the light emitting device and the display unit of the present invention, it is possible to enhance the brightness of the device and reduce the weight thereof by making use of laser oscillation of the laser structure of the present invention.

Since the laser structure can be synthesized in a self-organizing manner by depositing microparticles in liquid, it is possible to relatively simply produce a large quantity of the laser structures at a low cost.

While the embodiments of the present invention have been described using specific terms, such description is for illustrative purposes only, and it is to be understood that changes and variations may be made without departing from the spirit or scope of the following claims.

What is claimed is:

1. A laser structure comprising:
a plurality of microparticles cyclically arrayed;
wherein said laser structure causes laser oscillation with diffraction light due to Bragg reflection from said microparticles taken as pumping light.

2. A laser structure according to claim 1, wherein gaps among said microparticles are filled with a luminous material, said luminous material becoming luminous by means of light having a wavelength satisfying a Bragg condition for said microparticles.

3. A laser structure according to claim 2, wherein said luminous material is a pigment material.

4. A laser structure according to claim 2, wherein said luminous material is an organic electroluminescence material, and an electrode is provided for giving an electric field to said organic electroluminescence material.

5. A laser structure according to claim 1, said microparticles contain a luminous material, said luminous material becoming luminous by means of light having a wavelength satisfying a Bragg condition for said microparticles.

6. A laser structure according to claim 1, wherein said microparticles are semiconductor microparticles each having a band gap corresponding to said wavelength.

7. A laser structure according to claim 1, wherein said microparticles are made from either of an organic polymer material, an inorganic material, and a composite material thereof.

8. A light emitting device comprising:
a laser structure including a plurality of microparticles cyclically arrayed so as to cause laser oscillation with diffraction light due to Bragg reflection from said microparticles taken as pumping light; and
a pair of waveguides being in contact with said laser structure.

9. A light emitting device according to claim 8, wherein said laser structure has a laser medium in gaps among said microparticles or in said microparticles.

10. A display unit comprising:
waveguides arrayed in a matrix pattern; and
laser structures provided at respective intersections between said waveguides;
wherein said laser structure includes a plurality of microparticles cyclically arrayed so as to cause laser oscillation with diffraction light due to Bragg reflection from said microparticles taken as pumping light.

11. A display unit according to claim 10, wherein said laser structure is an element for emitting light of either of three primary colors; and
a set of said laser structures, which allow emission of light of the primary three colors, form each pixel.

12. A display unit according to claim 11, wherein the light emission of the three primary colors is performed by making a kind of pigment doped in said microparticles or put around said microparticles for one of said laser structures different from another kind of pigment doped in said microparticles or put around said microparticles for another of said laser structures.

13. A display unit comprising:
electrodes arrayed in a matrix pattern; and
a plurality of laser structures provided at respective intersections between said electrodes;
wherein said laser structure includes a plurality of microparticles cyclically arrayed, and gaps among said microparticles are filled with an organic electroluminescence material that becomes luminous by means of light having a wavelength satisfying a Bragg condition for said microparticles.

14. A display unit according to claim 13, wherein said laser structure is an element for emitting light of either of three primary colors; and
a set of said laser structures, which allow emission of light of the primary three colors, form each pixel.

15. A display unit comprising:
a plurality of laser structures formed on a transparent supporting plane, said laser structure including a plurality of microparticles cyclically arrayed so as to cause laser oscillation with diffraction light due to Bragg reflection from said microparticles taken as pumping light;
wherein said laser structures on said transparent supporting plane are irradiated with an electron beam that is scanned.

16. A display unit comprising:
a plurality of laser structures formed on a transparent supporting plane, each of said laser structures including a plurality of microparticles cyclically arrayed so as to cause laser oscillation with diffraction light due to Bragg reflection from said microparticles taken as pumping light;
wherein said laser structures on said transparent supporting plane are irradiated with a laser beam.

17. An optical amplifier comprising:
a laser structure disposed in a waveguide, said laser structure including a plurality of microparticles cyclically arrayed so as to cause laser oscillation with diffraction light due to Bragg reflection from said microparticles taken as pumping light;
wherein light passing through said waveguide is amplified by said laser structure.

18. An optical amplifier according to claim 17, wherein said waveguide is an optical fiber.

19. A method of producing a laser structure, comprising the steps of:
dispersing a plurality of microparticles in liquid; and
depositing said plurality of microparticles in a bottom portion of the liquid, thereby forming a laser structure composed of a cyclic array of said microparticles.

20. A method of producing a laser structure, comprising the steps of:
dispersing a plurality of electrically charged microparticles in liquid; and
depositing said plurality of microparticles in a bottom portion of the liquid by electrophoresis of said electrically charged microparticles, thereby forming a laser structure composed of a cyclic array of said microparticles.
